(19) United States
(12) Patent Application Publication
(10) Pub. No.: US 2006/0195543 A1
(43) Pub. Date: Aug. 31, 2006

(54) Hard disk-incorporated optical disk recording and reproducing apparatus

(75) Inventor: Takehiro Kose, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/360,380

(22) Filed: Feb. 24, 2006

(30) Foreign Application Priority Data
Feb. 28, 2005 (JP) 2005-054060

(51) Int. Cl. G06F 15/167

(52) U.S. Cl. 709/212

(57) ABSTRACT

There is provided a hard disk-incorporated optical disk recording and reproducing apparatus adapted to be capable of transferring a music file to an MP3 player without using a personal computer, etc. and to be capable of charging a battery in the MP3 player when the MP3 player is connected thereto. The apparatus is adapted to be connectable with an MP3 player B through a USB 9 including a signal line L1 and a power line L2 and comprises a CPU 3 so that a music file can be transferred to the MP3 player B through the signal line L1 and that a battery 26 in the MP3 player B can be charged through the power line L2. It is therefore possible to transfer a music file to the MP3 player B without using a personal computer, etc. It is also possible to charge the battery 26 when the MP3 player B is connected to the apparatus.

### BACKGROUND OF THE INVENTION

1. Field of the Invention

The present invention relates to a hard disk-incorporated optical disk recording and reproducing apparatus to which an MP3 player can be connected.

2. Description of the Prior Art

In recent years, DVDs (Digital Versatile Disks), which can record a larger amount of data than CDs (Compact Disks), have been in widespread use as optical disks. Thus, DVDs are mainly used to record a large amount of video/audio data such as movie data. Then, DVD recorders have also been in widespread use as optical disk recording and reproducing apparatuses for recording information onto a DVD and/or for reproducing information recorded on a DVD. In addition, hard disk-incorporated DVD recorders (hard disk-incorporated optical disk recording and reproducing apparatuses) are getting popular, in which is further provided a hard disk drive, which has conventionally been used as a storage device, for example, in a personal computer, to make it possible to record/reproduce information onto/from the hard disk.

There has also been known a video/audio information recording and reproducing apparatus achieved by integrally packaging specific functions of products such as digital camcorders, digital still cameras, MP3 players, and voice recorders (refer to Japanese Patent Laid-Open Publication No. 2004-215262). There has further been known a multifunctional optical disk drive unit used in a personal computer and having functions of CD drive units, DVD drive units, FM radios, and MP3 music CD players (refer to Japanese Patent Laid-Open Publication No. 2004-171745).

Meanwhile, although hard disk-incorporated DVD recorders are getting popular as mentioned above, it is demanded that such a hard disk-incorporated DVD recorder be used to transfer and record a music file into an MP3 player so that the music content can be played using the MP3 player. It is also demanded that a battery in the MP3 player can be charged when the MP3 player is connected to such a hard disk-incorporated DVD recorder.

However, although the prior art described in Japanese Patent Laid-Open Publication No. 2004-215262 is adapted to compress a sound signal from an MP3 player and to record the signal onto a hard disk, etc., the art is not adapted to use a hard disk-incorporated DVD recorder (hard disk-incorporated optical disk recording and reproducing apparatus) to transfer and record a music file into an MP3 player so that the music content can be played using the MP3 player. Also, the art is not adapted to be capable of charging a battery in the MP3 player when the MP3 player is connected to the hard disk-incorporated DVD recorder.

In addition, although the prior art described in Japanese Patent Laid-Open Publication No. 2004-171745 is adapted to play a music content using a multifunctional optical disk drive unit including functions of MP3 music CD players, the art is also not adapted to use a hard disk-incorporated DVD recorder (hard disk-incorporated optical disk recording and reproducing apparatus) to transfer and record a music file into an MP3 player so that the music content can be played using the MP3 player. Also, the art is not adapted to be capable of charging a battery in the MP3 player when the MP3 player is connected to the hard disk-incorporated DVD recorder (hard disk-incorporated optical disk recording and reproducing apparatus).

### SUMMARY OF THE INVENTION

The present invention has been made to solve the above-described problems, and an object thereof is to provide a hard disk-incorporated optical disk recording and reproducing apparatus adapted to be capable of transferring a music file to an MP3 player without using a personal computer, etc. and to be capable of charging a battery in the MP3 player when the MP3 player is connected thereto.

In order to achieve the foregoing object, the invention according to claim 1 provides a hard disk-incorporated optical disk recording and reproducing apparatus adapted to record/reproduce information onto/from an optical disk and to record/reproduce information also onto/from a hard disk, the apparatus being adapted to be connectable with an MP3 player through an interface including a signal line and a power line so that a music file can be transferred to the MP3 player through the signal line and that a battery in the MP3 player can be charged through the power line, and the apparatus comprising a central processing unit having: first compression format determining means for determining whether or not a music file recorded on the optical disk is based on a predetermined music compression format when fast-forwarding the optical disk to transfer the music file recorded on the optical disk to the MP3 player; first transferring means for transferring the music file directly to the MP3 player if it is determined that the music file recorded on the optical disk is based on the predetermined music compression format; first compression format converting means for converting the music file into the predetermined music compression format if it is determined that the music file recorded on the optical disk is not based on the predetermined music compression format; first storage means for storing the converted file onto the hard disk; second transferring means for retrieving the music file stored on the hard disk and for transferring the music file to the MP3 player when the fast-forwarding operation is completed; second compression format determining means for determining whether or not a music file recorded on the optical disk is based on a predetermined music compression format when normally playing the optical disk to transfer the music file recorded on the optical disk to the MP3 player; third transferring means for transferring the music file directly to the MP3 player if it is determined that the music file recorded on the optical disk is based on the predetermined music compression format; second compression format converting means for converting the music file into the predetermined music compression format if it is determined that the music file recorded on the optical disk is not based on the predetermined music compression format; second storage means for storing the converted file onto the hard disk; and fourth transferring means for retrieving the music file stored on the hard disk and for transferring the music file to the MP3 player when the normal playing operation is completed.

In the arrangement above, the hard disk-incorporated optical disk recording and reproducing apparatus is first connected with the MP3 player through the interface to transfer a music file from the hard disk-incorporated optical disk recording and reproducing apparatus to the MP3 player. Then, when fast-forwarding the optical disk to transfer a music file recorded on the optical disk to the MP3 player, the first compression format determining means determines whether or not the music file is based on a predetermined music compression format. If the music file is based on the predetermined music compression format, the first transferring means transfers the music file directly to the MP3 player.

On the contrary, if the music file is not based on the predetermined music compression format, the first compression format converting means converts the music file into the predetermined music compression format. Subsequently, the first storage means stores the converted music file onto the hard disk. Then, when the fast-forwarding operation is completed, the second transferring means retrieves the music file stored on the hard disk and transfers the music file to the MP3 player.

When normally playing the optical disk to transfer a music file recorded on the optical disk to the MP3 player, the second compression format determining means determines whether or not the music file is based on a predetermined music compression format. If the music file is based on the predetermined music compression format, the second transferring means transfers the music file directly to the MP3 player.

On the contrary, if the music file is not based on the predetermined music compression format, the second compression format converting means converts the music file read from the optical disk into the predetermined music compression format. Subsequently, the second storage means stores the converted music file onto the hard disk. Then, when the normal playing operation is completed, the fourth transferring means transfers the music file stored on the hard disk to the MP3 player.

Also, when the hard disk-incorporated optical disk recording and reproducing apparatus is connected with the MP3 player through the interface, the battery in the MP3 player is provided with a power supply voltage of the power supply section in the hard disk-incorporated optical disk recording and reproducing apparatus through the power line included in the interface. Therefore, the battery in the MP3 player is to be charged.

In accordance with the above arrangement, the hard disk-incorporated optical disk recording and reproducing apparatus can transfer a music file to the MP3 player, whereby the transferred music file can be recorded into the MP3 player, which therefore makes it possible also to listen to new music by reproducing the recorded music file, resulting in full use of the MP3 player. Also, since the hard disk-incorporated optical disk recording and reproducing apparatus can thus transfer a music file to the MP3 player, the versatility thereof can be increased. In addition, when the hard disk-incorporated optical disk recording and reproducing apparatus is connected with the MP3 player, the battery in the MP3 player can be charged, resulting in an improvement in user-friendliness.

The invention according to claim 2 provides a hard disk-incorporated optical disk recording and reproducing apparatus adapted to record/reproduce information onto/from an optical disk and to record/reproduce information also onto/from a hard disk, the apparatus being adapted to be connectable with an MP3 player through an interface including a signal line and a power line and comprising a central processing unit so that a music file can be transferred to the MP3 player through the signal line and that a battery in the MP3 player can be charged through the power line.

In the arrangement above, a music file from the hard disk-incorporated optical disk recording and reproducing apparatus is to be transferred to the MP3 player through the signal line included in the interface. Also, a power supply voltage of the hard disk-incorporated optical disk recording and reproducing apparatus is to be supplied to the battery in the MP3 player through the power line included in the interface.

In accordance with the above arrangement, the hard disk-incorporated optical disk recording and reproducing apparatus can transfer a music file to the MP3 player, whereby the transferred music file can be recorded into the MP3 player, which therefore makes it possible also to listen to new music by reproducing the recorded music file, resulting in full use of the MP3 player. Also, since the hard disk-incorporated optical disk recording and reproducing apparatus can thus transfer a music file to the MP3 player, the versatility thereof can be increased. In addition, when the hard disk-incorporated optical disk recording and reproducing apparatus is connected with the MP3 player, the battery in the MP3 player can be charged, resulting in an improvement in user-friendliness.

In the invention according to claim 3, the invention according to claim 2 is arranged in such a manner that the central processing unit has: first compression format determining means for determining whether or not a music file recorded on the optical disk is based on a predetermined music compression format when fast-forwarding the optical disk to transfer the music file recorded on the optical disk to the MP3 player; first transferring means for transferring the music file directly to the MP3 player if it is determined that the music file recorded on the optical disk is based on the predetermined music compression format; first compression format converting means for converting the music file into the predetermined music compression format if it is determined that the music file recorded on the optical disk is not based on the predetermined music compression format; first storage means for storing the converted file onto the hard disk; and second transferring means for retrieving the music file stored on the hard disk and for transferring the music file to the MP3 player when the fast-forwarding operation is completed.

Accordingly, the hard disk-incorporated optical disk recording and reproducing apparatus can achieve the processing of fast-forwarding the optical disk to retrieve a music file recorded on the optical disk and to transfer the music file to the MP3 player, which allows the music file to be transferred to the MP3 player at high speed.

In the invention according to claim 4, the invention according to claim 2 is arranged in such a manner that the central processing unit further has: second compression format determining means for determining whether or not a music file recorded on the optical disk is based on a predetermined music compression format when normally playing the optical disk to transfer the music file recorded on the optical disk to the MP3 player; third transferring means for transferring the music file directly to the MP3 player if it is determined that the music file recorded on the optical disk is based on the predetermined music compression format; second compression format converting means for converting the music file into the predetermined music compression format if it is determined that the music file recorded on the optical disk is not based on the predetermined music compression format; second storage means for storing the converted file onto the hard disk; and fourth transferring means for retrieving the music file stored on the hard disk and for transferring the music file to the MP3 player when the normal playing operation is completed.

Accordingly, the hard disk-incorporated optical disk recording and reproducing apparatus can achieve the processing of normally playing the optical disk to retrieve a music file recorded on the optical disk and to transfer the music file to the MP3 player, which allows the music file to be transferred to the MP3 player while a user listens to the music.

As described heretofore, in accordance with the present invention, in a hard disk-incorporated optical disk recording and reproducing apparatus adapted to record/reproduce information onto/from an optical disk and to record/reproduce information also onto/from a hard disk, the apparatus being adapted to be connectable with an MP3 player through an interface including a signal line and a power line so that a music file can be transferred to the MP3 player through the signal line and that a battery in the MP3 player can be charged through the power line, there is provided a central processing unit having: first compression format determining means for determining whether or not a music file recorded on an optical disk is based on a predetermined music compression format when fast-forwarding the optical disk to transfer the music file recorded on the optical disk to the MP3 player; first transferring means for transferring the music file directly to the MP3 player if it is determined that the music file recorded on the optical disk is based on the predetermined music compression format; first compression format converting means for converting the music file into the predetermined music compression format if it is determined that the music file recorded on the optical disk is not based on the predetermined music compression format; first storage means for storing the converted file onto the hard disk; second transferring means for retrieving the music file stored on the hard disk and for transferring the music file to the MP3 player when the fast-forwarding operation is completed; second compression format determining means for determining whether or not a music file recorded on an optical disk is based on a predetermined music compression format when normally playing the optical disk to transfer the music file recorded on the optical disk to the MP3 player; third transferring means for transferring the music file directly to the MP3 player if it is determined that the music file recorded on the optical disk is based on the predetermined music compression format; second compression format converting means for converting the music file into the predetermined music compression format if it is determined that the music file recorded on the optical disk is not based on the predetermined music compression format; second storage means for storing the converted file onto the hard disk; and fourth transferring means for retrieving the music file stored on the hard disk and for transferring the music file to the MP3 player when the normal playing operation is completed, whereby the hard disk-incorporated optical disk recording and reproducing apparatus can transfer a music file to the MP3 player without using a personal computer, etc., whereby the transferred music file can be recorded into the MP3 player, which therefore makes it possible also to listen to new music by reproducing the recorded music file, resulting in full use of the MP3 player. Also, since the hard disk-incorporated optical disk recording and reproducing apparatus can thus transfer a music file to the MP3 player, the versatility thereof can be increased. In addition, when the hard disk-incorporated optical disk recording and reproducing apparatus is connected with the MP3 player, the battery in the MP3 player can be charged, resulting in an improvement in user-friendliness.

Also, in accordance with the present invention, a hard disk-incorporated optical disk recording and reproducing apparatus adapted to record/reproduce information onto/from an optical disk and to record/reproduce information also onto/from a hard disk is adapted to be connectable with an MP3 player through an interface including a signal line and a power line and comprises a central processing unit so that a music file can be transferred to the MP3 player through the signal line and that a battery in the MP3 player can be charged through the power line, whereby the hard disk-incorporated optical disk recording and reproducing apparatus can transfer a music file to an MP3 player without using a personal computer, etc., whereby the transferred music file can be recorded into the MP3 player, which therefore makes it possible also to listen to new music by reproducing the recorded music file, resulting in full use of the MP3 player. Also, since the hard disk-incorporated optical disk recording and reproducing apparatus can thus transfer a music file to the MP3 player, the versatility thereof can be increased. In addition, when the hard disk-incorporated optical disk recording and reproducing apparatus is connected with the MP3 player, the battery in the MP3 player can be charged, resulting in an improvement in user-friendliness.

### BRIEF DESCRIPTION OF THE DRAWINGS

FIG. 1 is a block diagram showing the configuration of a hard disk-incorporated DVD recorder as a hard disk-incorporated optical disk recording and reproducing apparatus according to an embodiment of the present invention and the configuration of an MP3 player connected to the DVD recorder;

FIG. 2 is a flow chart for illustrating a process of transferring a music file from the hard disk-incorporated DVD recorder to the MP3 player in the embodiment; and

FIG. 3 is a flow chart for illustrating a process of charging a battery in the MP3 player when the hard disk-incorporated DVD recorder is connected with the MP3 player in the embodiment.

### DESCRIPTION OF THE PREFERRED EMBODIMENTS

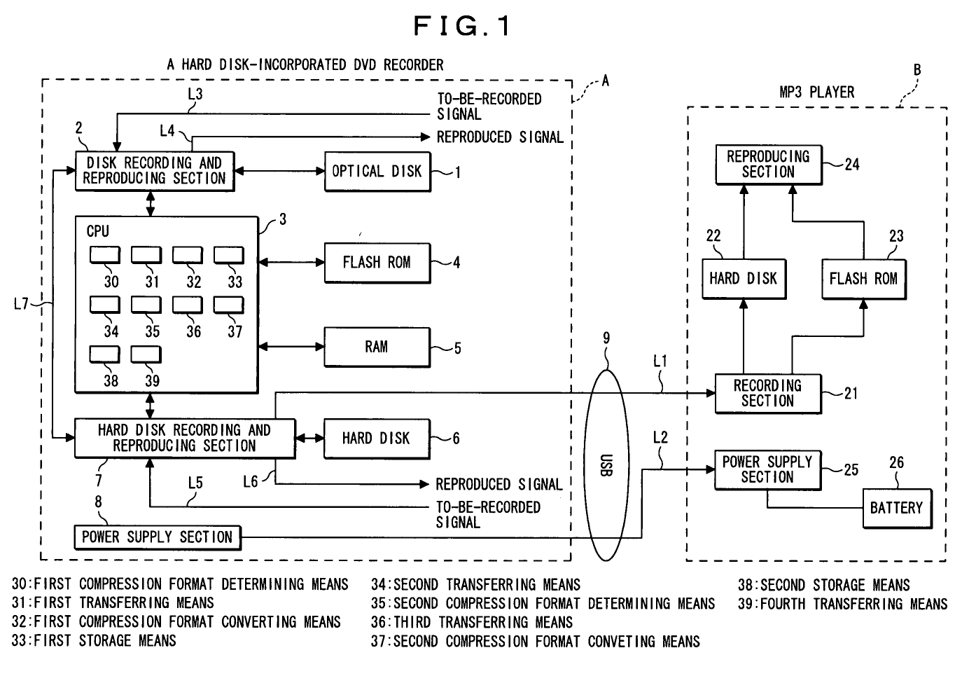

An embodiment of the present invention will hereinafter be described with reference to the accompanying drawings. FIG. 1 is a block diagram showing the configuration of a hard disk-incorporated DVD recorder as a hard disk-incorporated optical disk recording and reproducing apparatus according to an embodiment of the present invention and the configuration of an MP3 player connected to the DVD recorder.

In FIG. 1, the hard disk-incorporated DVD recorder A comprises: a disk recording and reproducing section (referred to also as disk drive) 2 for recording/reproducing information onto/from an optical disk (CD or DVD) 1; a hard disk recording and reproducing section (referred to also as hard disk drive) 7 for recording/reproducing information onto/from a hard disk 6; a CPU (Central Processing Unit) 3 for controlling each component in the DVD recorder A and for performing specified processing; a flash ROM 4 with programs and data required for the control and processing in the CPU 3 stored therein; a RAM 5 for temporarily storing data required for the control and processing in the CPU 3; and a power supply section 8 for supplying a power supply voltage to each component in the DVD recorder A.

It is noted that the disk recording and reproducing section 2 can receive a video/audio signal from a TV tuner and/or other video/audio reproduction devices through a line L3 to record the video/audio signal, and can reproduce a video/audio signal recorded on the optical disk 1 to output the signal to a TV receiver, etc. through a line L4. Also, the hard disk recording and reproducing section 7 can receive a video/audio signal from a TV tuner and/or other video/audio reproduction devices through a line L5 to record the video/audio signal, and can reproduce a video/audio signal recorded on the hard disk 6 to output the signal to a TV receiver, etc. through a line L6. In addition, it is possible to input a reproduced signal from the disk recording and reproducing section 2 to the hard disk recording and reproducing section 7 through a line L7, while to input a reproduced signal from the hard disk recording and reproducing section 7 to the disk recording and reproducing section 2 through the line L7, which allows information on the optical disk 1 to be recorded onto the hard disk 6, while information on the hard disk 6 to be recorded onto the optical disk 1.

The CPU 3 has: first compression format determining means 30 for determining whether or not a music file recorded on the optical disk 1 is based on a predetermined music compression format when fast-forwarding the optical disk 1 to transfer the music file recorded on the optical disk 1 to the MP3 player B; first transferring means 31 for transferring the music file directly to the MP3 player B if it is determined that the music file recorded on the optical disk 1 is based on the predetermined music compression format; first compression format converting means 32 for converting the music file into the predetermined music compression format if it is determined that the music file recorded on the optical disk 1 is not based on the predetermined music compression format; first storage means 33 for storing the converted file onto the hard disk 6; and second transferring means 34 for retrieving the music file stored on the hard disk 6 and for transferring the music file to the MP3 player B when the fast-forwarding operation is completed.

The CPU 3 also has: second compression format determining means 35 for determining whether or not a music file recorded on the optical disk 1 is based on a predetermined music compression format (e.g. MP3 compression format, WAVE compression format, or WMA compression format) when normally playing the optical disk 1 to transfer the music file recorded on the optical disk 1 to the MP3 player B; third transferring means 36 for transferring the music file directly to the MP3 player B if it is determined that the music file recorded on the optical disk 1 is based on the predetermined music compression format; second compression format converting means 37 for converting the music file into the predetermined music compression format (e.g. MP3 compression format, WAVE compression format, or WMA compression format) if it is determined that the music file recorded on the optical disk 1 is not based on the predetermined music compression format; second storage means 38 for storing the converted file onto the hard disk 6; and fourth transferring means 39 for retrieving the music file stored on the hard disk 6 and for transferring the music file to the MP3 player B when the normal playing operation is completed.

The MP3 player B comprises: a recording section 21 for recording a music file sent from the DVD recorder A through a USB (Universal Serial Bus) 9 onto a hard disk 22 or a flash ROM 23; a reproducing section 24 for retrieving and reproducing the music file recorded on the hard disk 22 or the flash ROM 23; and a power supply section 25 having a battery 26 for supplying a power supply voltage to each component in the MP3 player B. An output terminal of the hard disk recording and reproducing section 7 in the DVD recorder A is connected to the recording section 21 in the MP3 player B through, for example, a signal line L1 included in the USB 9, and an output terminal of the power supply section 8 in the DVD recorder A is connected to the power supply section 25 through, for example, a power line L2 included in the USB 9.

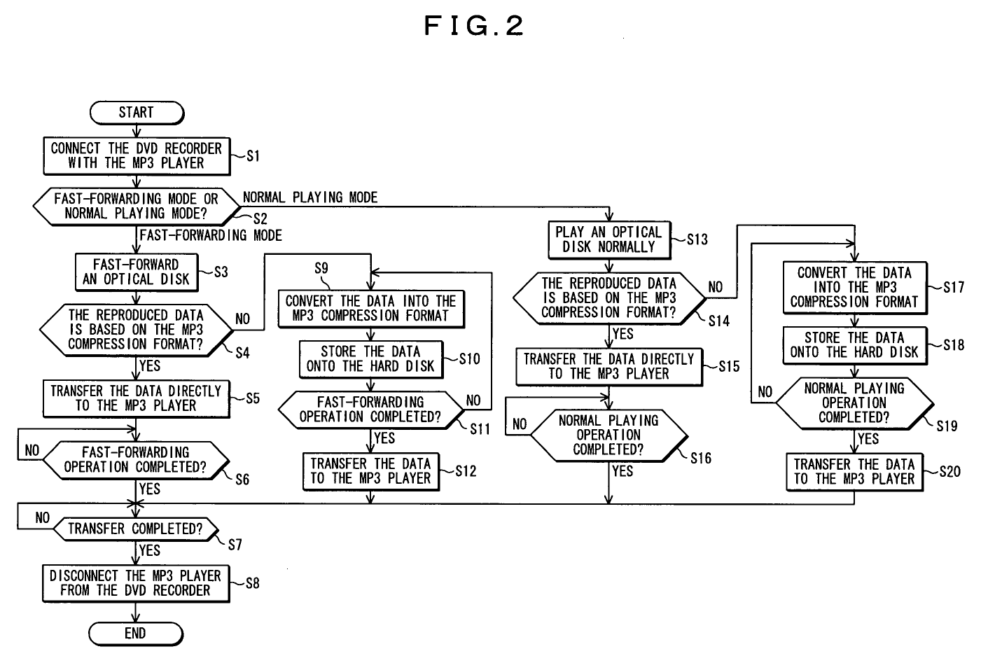

Fig.2 is a flow chart for illustrating a process of transferring a music file from the hard disk-incorporated DVD recorder A to the MP3 player B in the present embodiment. A process of transferring a music file from the hard disk-incorporated DVD recorder A to the MP3 player B will be described with reference to this flow chart. It is noted that although the following processing will be described on the assumption that the music file is based on the MP3 compression format, if based on the WAVE compression format or the WMA compression format, the same processing can be performed by converting the music file into the corresponding compression format.

The hard disk-incorporated DVD recorder A is first connected with the MP3 player B through the USB 9 to transfer a music file from the hard disk-incorporated DVD recorder A to the MP3 player B (step S1). Then, a user determines whether to use the fast-forwarding mode for transfer processing or to use the normal playing mode for transfer processing while playing and listening to the music through a key operation using a remote controller, etc.

If it is determined to use the fast-forwarding mode through the key operation (step S2), the disk recording and reproducing section 2 fast-forwards the optical disk 1 under the control of the CPU 3 (step S3). This causes the disk recording and reproducing section 2 to read music file data recorded on the optical disk 1 at high speed and to output reproduced data. Then, the first compression format determining means 30 in the CPU 3 refers to the disk information to determine whether or not the reproduced data (reproduced music file) is based on the MP3 compression format (step S4).

If the reproduced data is based on the MP3 compression format, that is, the music file recorded on the optical disk 1 that is currently installed in the DVD recorder A is based on the MP3 compression format, the first transferring means 31 in the CPU 3 transfers the reproduced data (reproduced music file) directly to the MP3 player B through the USB 9 (step S5). In this case, the reproduced data from the disk recording and reproducing section 2 passes through the hard disk recording and reproducing section 7 to be sent to the USB 9 and then transferred to the MP3 player B. Alternatively, the reproduced data from the disk recording and reproducing section 2 may be sent to the USB 9 directly and then transferred to the MP3 player B. Subsequently, when the fast-forwarding operation is completed (step S6) and the transfer operation is completed (step S7), the MP3 player B is disconnected from the DVD recorder A (step S8) to complete the present processing.

Meanwhile, in step S4, if the reproduced data is not based on the MP3 compression format, that is, the music file recorded on the optical disk 1 that is currently installed in the DVD recorder A is not based on the MP3 compression format, the first compression format converting means 32 in the CPU 3 stores reproduced data to be converted sequentially onto the RAM 5 temporarily, and then converts the reproduced data (music file) into the MP3 compression format (step S9). The CPU 3 controls the hard disk recording and reproducing section 7 in such a manner that the first storage means 33 stores the converted reproduced data (music file) onto the hard disk 6 (step S10).

Then, when the fast-forwarding operation is completed (step S11), the second transferring means 34 in the CPU 3 retrieves the music file stored on the hard disk 6 through the hard disk recording and reproducing section 7, and then transfers the music file to the MP3 player B (step S12). When the transfer operation is completed (step S7), the MP3 player B is disconnected from the DVD recorder A (step S8) to complete the present processing. When the MP3 player B is disconnected from the DVD recorder A, the MP3 player B becomes available as a portable player that can be driven by the battery 26 incorporated therein.

Next, if it is determined to use the normal playing mode through the key operation using the remote controller, etc. (step S2), the disk recording and reproducing section 2 plays the optical disk 1 normally under the control of the CPU 3 (step S13). This causes the disk recording and reproducing section 2 to read information on the optical disk 1 and to output reproduced data (music file). Then, the second compression format determining means 35 in the CPU 3 refers to the disk information to determine whether or not the reproduced data (music file) is based on the MP3 compression format (step S14).

If the reproduced data (music file) is based on the MP3 compression format, that is, the music file recorded on the optical disk 1 that is currently installed in the DVD recorder A is based on the MP3 compression format, the third transferring means 36 in the CPU 3 transfers the reproduced data (music file) directly to the MP3 player B through the USB 9 (step S15). In this case, the reproduced data from the disk recording and reproducing section 2 passes through the hard disk recording and reproducing section 7 to be sent to the USB 9 and then transferred to the MP3 player B. Alternatively, the reproduced data from the disk recording and reproducing section 2 may be sent to the USB 9 directly and then transferred to the MP3 player B. Subsequently, when the normal playing operation is completed (step S16) and the transfer operation is completed (step S7), the MP3 player B is disconnected from the DVD recorder A (step S8) to complete the present processing. When the MP3 player B is disconnected from the DVD recorder A, the MP3 player B becomes available as a portable player that can be driven by the battery 26 incorporated therein.

Meanwhile, in step S14, if the reproduced data is not based on the MP3 compression format, that is, the music file recorded on the optical disk 1 that is currently installed in the DVD recorder A is not based on the MP3 compression format, the second compression format converting means 37 in the CPU 3 stores reproduced data to be converted sequentially onto the RAM 5 temporarily, and then converts the reproduced data (music file) into the MP3 compression format (step S17). The CPU 3 controls the hard disk recording and reproducing section 7 in such a manner that the second storage means 38 stores the converted music file onto the hard disk 6 (step S18).

Then, when the normal playing operation is completed (step S19), the fourth transferring means 39 in the CPU 3 retrieves the music file stored on the hard disk 6 through the hard disk recording and reproducing section 7, and then transfers the music file to the MP3 player B (step S20). When the transfer operation is completed (step S7), the MP3 player B is disconnected from the DVD recorder A (step S8) to complete the present processing. When the MP3 player B is disconnected from the DVD recorder A, the MP3 player B becomes available as a portable player that can be driven by the battery 26 incorporated therein.

It is noted that in the above-described transfer processing, if the music file reproduced from the optical disk 1 in the DVD recorder A is not based on the MP3 compression format, the music file is converted into the MP3 compression format and the converted music file is entirely stored on the hard disk 6 until the fast-forwarding operation or the normal playing operation is completed to subsequently be retrieved from the hard disk 6 and then transferred to the MP3 player B, where it is also possible to transfer the music file stored on the hard disk 6 to the MP3 player B little by little during the fast-forwarding operation or the normal playing operation. In this case, it is however necessary for the CPU 3 to perform fast-forward or normal playing processing, conversion processing, storage processing, and transfer processing almost in parallel, resulting in a tendency of the overall processing to be complicated. Although the CPU 3 can perform the foregoing processing almost in parallel, it is actually impossible to perform, for example, storage processing onto the hard disk 6 and retrieving and transfer processing from the hard disk 6 at the same time, resulting rather in a possibility of taking a long time to complete the transfer operation.

In accordance with the transfer processing according to the present embodiment, the hard disk-incorporated DVD recorder A can transfer a music file to the MP3 player B without using a personal computer, etc., whereby the transferred music file can be recorded into the MP3 player B, which therefore makes it possible also to listen to new music by reproducing the recorded music file, resulting in full use of the MP3 player. Also, since the hard disk-incorporated DVD recorder A can thus transfer a music file to the MP3 player, the versatility thereof can be increased.

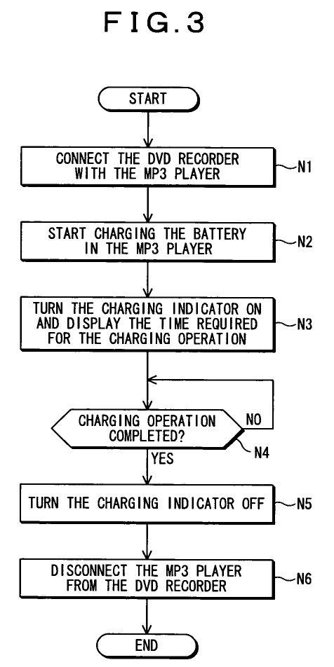

FIG. 3 is a flow chart for illustrating a process of charging the battery 26 in the MP3 player B when the hard disk-incorporated DVD recorder A is connected with the MP3 player B. A process of charging the battery 26 in the MP3 player B when the hard disk-incorporated DVD recorder A is connected with the MP3 player B will be described with reference to this flow chart.

When the DVD recorder A is connected with the MP3 player B through the USB 9 (step N1), the output terminal of the power supply section 8 in the DVD recorder A is connected to the input terminal of the power supply section 25 in the MP3 player B through the power line L2. This causes a power supply voltage of the power supply section 8 in the DVD recorder A to be supplied to the power supply section 25 in the MP3 player B to start charging the battery 26 (step N2).

When the charging operation is started, a charging indicator, etc. (not shown in the figure) for indicating that the MP3 player B is charged is turned on, and the time required for the charging operation will be displayed on a display section (not shown in the figure) (step N3). It is noted that turning the charging indicator on during the charging operation can be achieved by providing a circuit for detecting that a voltage is applied to the input terminal of the power supply section 25. Also, displaying the time required for the charging operation can be achieved by measuring the voltage of the battery 26 before the charging operation and providing a circuit for calculating the charging time that corresponds to the reduction of the voltage.

Then, when the time required for the charging operation has passed to complete the charging operation (step N4), the charging indicator is turned off (step N5). This indicates the completion of the charging operation, and the MP3 player B is disconnected from the DVD recorder A (step N6). It is noted that although the user is informed of the completion of the charging operation by turning the charging indicator off in the present example, a buzzer, etc. may be used to inform the user of the completion of the charging operation. Also, the process of detecting the completion of the charging operation when the DVD recorder A is in a playing operation and stopping the playing operation may be used to inform the user of the completion of the charging operation.

As mentioned above, it is possible to charge the battery 26 in the MP3 player B when the hard disk-incorporated DVD recorder A is connected with the MP3 player B, resulting in an improvement in user-friendliness.

What is claimed is:

1. A hard disk-incorporated optical disk recording and reproducing apparatus adapted to record/reproduce information onto/from an optical disk and to record/reproduce information also onto/from a hard disk,
said apparatus being adapted to be connectable with an MP3 player through an interface including a signal line and a power line so that a music file can be transferred to said MP3 player through said signal line and that a battery in said MP3 player can be charged through said power line, and
said apparatus comprising a central processing unit having:
first compression format determining means for determining whether or not a music file recorded on said optical disk is based on a predetermined music compression format when fast-forwarding said optical disk to transfer said music file recorded on said optical disk to said MP3 player;
first transferring means for transferring said music file directly to said MP3 player if it is determined that said music file recorded on said optical disk is based on said predetermined music compression format;
first compression format converting means for converting said music file into said predetermined music compression format if it is determined that said music file recorded on said optical disk is not based on said predetermined music compression format;
first storage means for storing said converted file onto said hard disk;
second transferring means for retrieving said music file stored on said hard disk and for transferring said music file to said MP3 player when said fast-forwarding operation is completed;
second compression format determining means for determining whether or not a music file recorded on said optical disk is based on a predetermined music compression format when normally playing said optical disk to transfer said music file recorded on said optical disk to said MP3 player;
third transferring means for transferring said music file directly to said MP3 player if it is determined that said music file recorded on said optical disk is based on said predetermined music compression format;
second compression format converting means for converting said music file into said predetermined music compression format if it is determined that said music file recorded on said optical disk is not based on said predetermined music compression format;
second storage means for storing said converted file onto said hard disk; and
fourth transferring means for retrieving said music file stored on said hard disk and for transferring said music file to said MP3 player when said normal playing operation is completed.

2. A hard disk-incorporated optical disk recording and reproducing apparatus adapted to record/reproduce information onto/from an optical disk and to record/reproduce information also onto/from a hard disk, said apparatus being adapted to be connectable with an MP3 player through an interface including a signal line and a power line and comprising a central processing unit so that a music file can be transferred to said MP3 player through said signal line and that a battery in said MP3 player can be charged through said power line.

3. The hard disk-incorporated optical disk recording and reproducing apparatus according to claim 2, wherein said central processing unit has:
first compression format determining means for determining whether or not a music file recorded on said optical disk is based on a predetermined music compression format when fast-forwarding said optical disk to transfer said music file recorded on said optical disk to said MP3 player;
first transferring means for transferring said music file directly to said MP3 player if it is determined that said music file recorded on said optical disk is based on said predetermined music compression format;
first compression format converting means for converting said music file into said predetermined music compression format if it is determined that said music file recorded on said optical disk is not based on said predetermined music compression format;
first storage means for storing said converted file onto said hard disk; and
second transferring means for retrieving said music file stored on said hard disk and for transferring said music file to said MP3 player when said fast-forwarding operation is completed.

4. The hard disk-incorporated optical disk recording and reproducing apparatus according to claim 2, wherein said central processing unit further has:
second compression format determining means for determining whether or not a music file recorded on said optical disk is based on a predetermined music compression format when normally playing said optical disk to transfer said music file recorded on said optical disk to said MP3 player;
third transferring means for transferring said music file directly to said MP3 player if it is determined that said music file recorded on said optical disk is based on said predetermined music compression format;
second compression format converting means for converting said music file into said predetermined music compression format if it is determined that said music file recorded on said optical disk is not based on said predetermined music compression format;
second storage means for storing said converted file onto said hard disk; and
fourth transferring means for retrieving said music file stored on said hard disk and for transferring said music file to said MP3 player when said normal playing operation is completed.
